(19) United States
(12) Patent Application Publication
(10) Pub. No.: US 2015/0132730 A1
(43) Pub. Date: May 14, 2015

(54) SENSOR MEMORY KITS AND METHOD FOR IMPROVING MEMORY

(71) Applicant: Katy Drorit Gaines, Los Angeles, CA (US)

(72) Inventor: Katy Drorit Gaines, Los Angeles, CA (US)

(21) Appl. No.: 14/514,274

(22) Filed: Oct. 14, 2014

Related U.S. Application Data
(60) Provisional application No. 61/890,525, filed on Oct. 14, 2013.

(51) Int. Cl. G09B 19/00

(52) U.S. Cl. CPC G09B 19/00
USPC 434/236

(57) ABSTRACT

A kit for improving or stimulating a human's memory comprises a set of sensible materials for the human to sense and a set of instructions for using the kit. The set of instructions comprises the steps of: (a) presenting the human with a material from a set of sensible materials; (b) instructing the human to sense the material; (c) instructing the human to identify the material; (d) recording the responses; (e) eliciting from the human at least a memory associated with the material; (f) recording the memory elicited in step (e); (g) instructing the human to sense the same material that the human is instructed to sense in the step (b); and (h) instructing the human to identify the material the human is instructed to sense in the step (g).

### CROSS REFERENCE TO RELATED APPLICATIONS

This application claims the benefit of U.S. Provisional Application No. 61/890,525 filed Oct. 14, 2013, which is incorporated herein by reference in its entirety.

### FIELD OF THE INVENTION

The present invention relates to kits for use in improving memory and related methods.

### BACKGROUND OF THE INVENTION

There are many people who have memory problems, particularly those who are elderly and those who have brain disorders or mental conditions, which result in an impairment of memory. Currently, there are few techniques, majority of which are non-sensory, which are offered to improve memory and their effectiveness is still in question. Accordingly, a need exists for a method for facilitating the improvement of those who are memory impaired.

### SUMMARY OF THE PREFERRED EMBODIMENTS

In accordance with an aspect of the present invention there is provided a kit for improving a human's memory, by capitalizing on the relationship between sensory stimulation and encoding in long-term memory.

In accordance with another aspect of the present invention there is provided a method for improving a human's memory.

In accordance with yet another aspect of the present invention there are provided apparatuses for improving a human's memory.

The invention, together with additional features and advantages thereof, may be best understood by reference to the following description.

### BRIEF DESCRIPTION OF THE DRAWINGS

FIG. 1a is a schematic front view of an exemplary embodiment of a sensor memory kit for improving or stimulating a human's memory according to the present invention;

FIG. 1b is a schematic front view of another exemplary embodiment of a sensor memory kit for improving or stimulating a human's memory according to the present invention;

FIG. 1c is a schematic front view of a component of yet another exemplary embodiment of a sensor memory kit for improving or stimulating a human's memory according to the present invention;

FIG. 1d is a schematic front view of a component of still another exemplary embodiment of a sensor memory kit for improving or stimulating a human's memory according to the present invention; and

FIG. 2 is a flow chart illustrating an exemplary embodiment of a method for improving or stimulating a human's memory according to the present invention.

### DETAILED DESCRIPTION OF THE PREFERRED EMBODIMENTS

The following description and drawings are illustrative and are not to be construed as limiting. Numerous specific details are described to provide a thorough understanding of the disclosure. However, in certain instances, well-known or conventional details are not described in order to avoid obscuring the description. References to one or an other embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. Appearances of the phrase “in one embodiment” in various places in the specification do not necessarily refer to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure.

Consequently, alternative language and synonyms may be used for any one or more of the terms discussed herein. Nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “side,” “portion,” “surface,” “facet” and “under” used herein are merely for ease of description and refer to the orientation of the components as shown in the figures. It should be understood that any orientation of the components described herein is within the scope of the present invention.

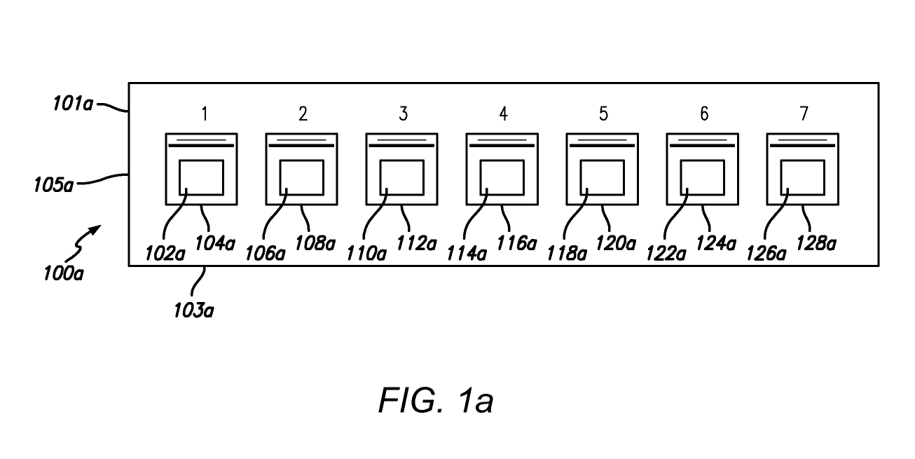

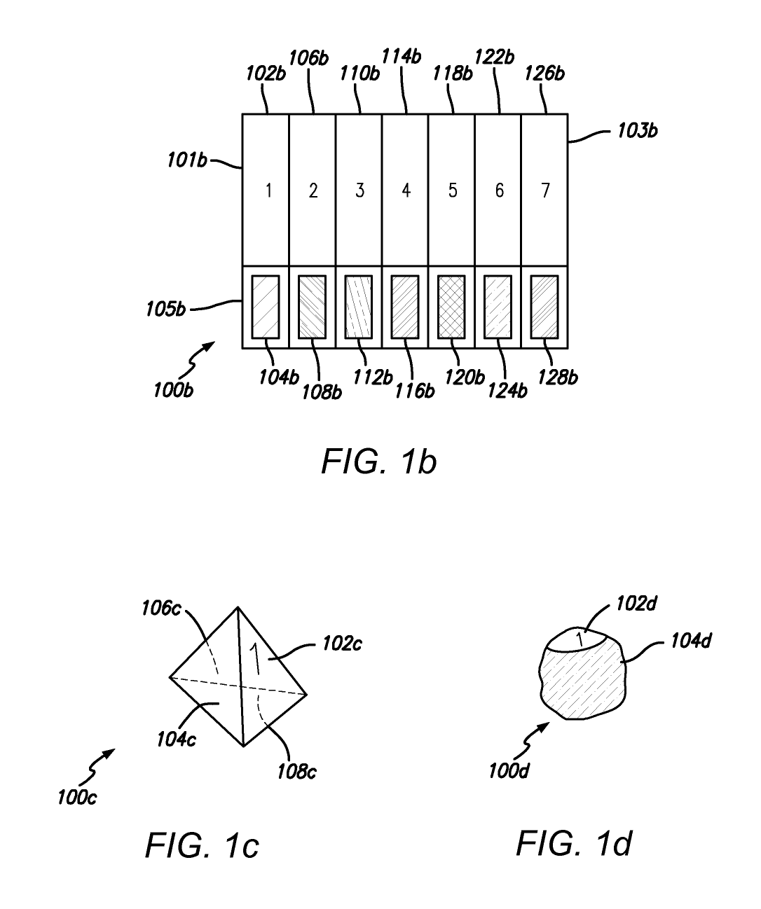

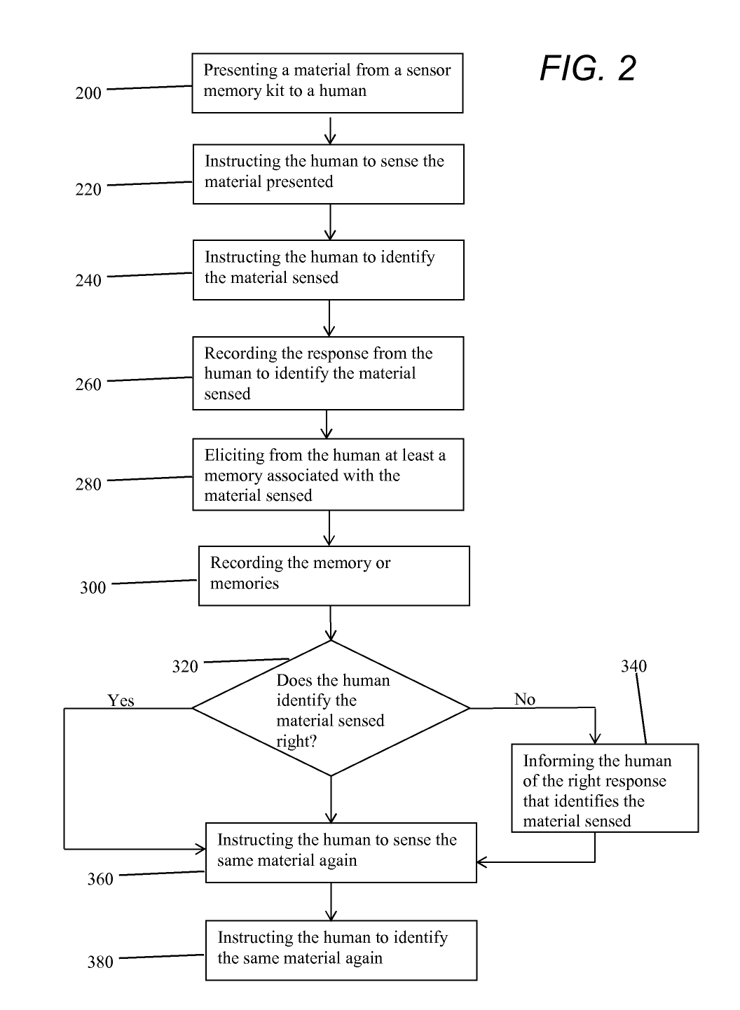

Referring now to the drawings, wherein the showings are for purposes of illustrating the present invention and not for purposes of limiting the same, FIG. 1 shows a variety of exemplary sensor memory kits and components of sensor memory kits according to the present invention. FIG. 2 shows an exemplary flow chart for improving a human's memory according to the present invention.

In a preferred embodiment, as shown in FIG. 1a, an olfactory kit 100a may include a set of olfactory stimulants (not shown) for the human to smell. Preferably, the olfactory stimulants may be scents. More preferably, each of the set of olfactory stimulants may be a scent selected from a different primary category of scents, such primary category including, but not limited to, citrus (e.g. orange), mint (e.g. peppermint), pine or woody (e.g. eucalyptus), flowery (e.g. rose), sour or acid or vinegar (e.g. lemon), fragrant or herbal (e.g. basil), musk (e.g. deer musk), sweet (e.g. vanilla), malt (e.g. coffee), pungent (e.g. blue cheese), non-citrus fruity (e.g. apple), chemical (e g ammonia), toasted or nutty (e.g. popcorn), and decayed smell (e.g. sour milk). Each primary category may include multiple scents and such multiple scents may be interchangeable for the purposes of administering a primary category of scent to a human. For example, sweet may include vanilla, almond and chocolate, non-citrus may include apple and pineapple, chemical may include ammonia and chlorine, toasted or nutty may include popcorn and bakery, sour may include lemon and vinegar. Certain scents of certain primary categories are relatively sharp and strong, therefore relatively easy for a human to detect and identify upon smelling. Scents from the categories of citrus, mint, pine or woody are among those easy for a human to identify. On the other hand, scents of certain other primary categories tend to be relatively soft and subtle, therefore relatively more difficult for a human to identify upon smelling. Scents from the categories of flowery and herbal are among those more difficult for a human to identify. Preferably, the set of olfactory stimulants may be organized in the order based on the levels of difficulty for a human to identify upon smelling. The set of olfactory stimulants may include any number of scents. Preferably, the set of olfactory stimulants may include from about 4 to about 10 scents. More preferably, the set of olfactory stimulants may include from about 6 to about 8 scents. Optimally, the set of olfactory stimulants may include 7 scents. Alternatively, a set of 7 scents may be a set of scents in the order of orange, peppermint, cinnamon, eucalyptus, rose, lemon and basil.

As shown in FIG. 1a, each different scent may be carried by a respective scent retainer 102a, 106a, 110a, 114a, 118a, 122a and 126a and preserved by enclosing the scent retainer retaining the scent in a respective scent retainer enclosure 104a, 108a, 112a, 116a, 120a, 124a and 128a. The scent retainer may be comprised of a piece of material that is capable of providing good odor retention. Preferably, such materials may be selected from the group including, but not limited to, fabric, paper, cotton, plastic, natural or synthetic wool, and the combinations thereof Preferably, such scent retainer is comprised of materials of identical color for the purposes of avoiding color interfering with the process of a human smell the scent retained by the scent retainer. Both the size and the thickness of the scent retainer may be flexible. Preferably, the size of the scent retainer may be from about 0.5 inch to about 3 inches in both length and width, and the thickness of the scent retainer may be from about moderate thick to about heavy thick. More preferably, the size of the scent retainer is about 1.5 inches by about 1.5 inches. Alternatively, oils or other chemicals may also be sprayed onto the scent retainer for the purposes of enhancing the preservation of the scent retained by the scent retainer. Such oils and chemicals may not compromise, interfere or alter the scent retained by the scent retainer. Optimally, Durascent® may be included as a preservation enhancer.

A scent retainer enclosure may be utilized to store the scent retainer so that the potency of the scent sprayed onto the scent retainer may be preserved. In addition, the enclosure of scents prevents olfactory interference of previous scents into the experience of the next scent. Preferably, the scent retainer enclosure may not reflect light to the extent of distracting the human from the smelling. Neither may the scent retainer enclosure affect the quality of the scent retained on the scent retainer, nor interfere with the human sensing the scent in any other manners. More preferably, the enclosure is comprised of see-through identical materials so as to reduce bias, curiosity and angst from the human. Preferably, the scent retainer enclosure may stores the scent retainer in a substantially air-tight manner. More preferably, the scent retainer enclosure may store the scent retainer in an air-tight manner with an opening for re-administering the scent preserved therein to a human for sensing. Alternatively, the scent retainer enclosure may be a see-through thick plastic bag and may be completely enclosed with a zip line as the air-tight and the re-opening mechanism.

Since all scents evaporate over time, it is recommended that a practitioner of the sensory kit may replace the stored scent retainers with a fresh scent retainer freshly sprayed with a scent, after repeated use or administering of the same scent retainer. Such practice may function as a control mechanism against diminished and consequently hard to perceive scent retained on the scent retainer. Each scent may have different evaporation rate that may affect the guidelines in terms of when to replace the scent. Preferably, the olfactory kit may include multiple scent sources (not shown), multiple unused scent retainers (not shown) and multiple unused scent retainer enclosures (not shown) for multiple use and administering of scents to a human. More preferably, the kit may further include an administration manual (not shown) that describes the scents, the primary scent categories and recommended frequencies of replacing a scent source, scent retainer, and scent retainer enclosure, response recording instructions giving the option of standardized administration, and instructions as to how to proceed if performance deviates from protocol of standard responses. Optimally, the olfactory kit may further include a mechanism to organize the scents included in the kit in the order of the level of difficulty for a human to identify upon sensing. Alternatively, the olfactory kit may further include a piece of material 103a sufficiently large for placing and holding 7 scent retainer enclosures in a displaying portion 105a under a numbering portion 101a which may include a series of numbers 1 through 7. Numbering portion 101a provides the numbers 1 through 7 as identifying presentations to the human, while the displaying portion 105a holds enclosed scent retainers 102a, 106a, 110a, 114a, 118a, 122a and 126a as sensing presentations to the human. Such piece of material may be comprised of cardboard, plastic, metal, fabric, wood, stone, etc.

In another preferred embodiment, as shown in FIG. 1b, a sensor tactile kit 100b may include a set of materials for a human to touch. Preferably, the sensor tactile kit materials may be fabrics. More preferably, each of the set of the sensor tactile kit materials may be a fabric that is capable of elicit a unique tactile experience. Optimally, such unique tactile experience may elicit a memory, including but not limited to major life events such as an engagement, a wedding, a new baby and a new pet. Such fabrics may be man-made or natural, or the combination thereof, selected from the group including, but not limited to, silk, corduroy, towel, flannel, plastic or vinyl, burlap, refined or coarse wool, leather, polyester, taffeta, denim, spandex, georgette, polypropylene, satin, fiberglass, filter, carbon, vinyl, plain, blended, polytetrafluoroethylene (PTFE), crewel, stretch, linen, ramie, hemp, leather, jute, rayon, acetate, chiffon, acrylic, organza, latex, nylon, velvet, viscose, grey fabric, reflective fabric, quilted fabric, polyethylene fabric, narrow fabric, laminated fabric, flocked fabric, flame resistant fabric, and the combination thereof Certain fabrics are more commonplace and universal, coarse or smooth, and therefore relatively easy for a human to identify upon touching. Fabrics such as silk and corduroy are among those easy for a human to identify. On the other hand, certain fabrics are rare, therefore relatively more difficult for a human to identify upon touching. Burlap and refined or coarse wool are among those relatively more difficult for a human to identify upon touching. Preferably, the set of fabrics may be organized in the order based on the levels of difficulty for a human to identify upon touching. The set of fabrics may include any number of fabrics. Preferably, the set of fabrics may include from about 4 to about 10 fabrics. More preferably, the set of fabrics may include from about 6 to about 8 fabrics. Optimally, the set of fabrics may include 7 fabrics. Alternatively, a set of 7 fabrics may be a set of fabrics in the order of silk, corduroy, towel, flannel, plastic or vinyl, burlap, and refined or coarse wool.

In a preferred embodiment, as shown in FIG. 1b, a sensor tactile kit 100b may include a set of fabric materials 104b, 108b, 112b, 116b, 120b, 124b and 128b for a human to touch. Preferably, the sensor tactile kit 100b may include an object 103b that includes a numbering side or guessing side 101b and fabric side 105b. The numbering side 103b may further include a series of numbers 1 through 7 labeled in portion 102b, 106b, 110b, 114b, 118b, 122b and 126b, respectively. The numbers labeled on the numbering side 101b each corresponds to a fabric displayed on the fabric side 105b. Fabric materials 104b, 108b, 112b, 116b, 120b, 124b and 128b may be attached onto the respective sub-portion of fabric side 105b, or each respective portion of fabric side 105b may be comprised of fabric materials 104b, 108b, 112b, 116b, 120b, 124b and 128b. Numbering side or guessing side 101b provides the numbers 1 through 7 as identifying presentations to the human, while fabric side 105b having fabric materials 104b, 108b, 112b, 116b, 120b, 124b and 128b attached onto, or fabric side 105b comprised of fabric materials 104b, 108b, 112b, 116b, 120b, 124b and 128b, provide sensing presentations to the human. Both the size and the thickness of fabrics 104b, 108b, 112b, 116b, 120b, 124b and 128b may be flexible. Preferably, the size and the thickness of fabric materials may be of the generally acceptable ranges of mild, moderate, or heavy thickness. More preferably, the size of fabric material is from about 1 inch to about 3 inches by from about 1 to about 3 inches. The thickness of fabric material is from about 0.01 inch to about 0.5 inches.

In yet another preferred embodiment, as shown in FIG. 1c, a sensor tactile kit may include a set of object(s) 100c. Object 100c may comprise multiple sides or facets, with one of the sides or facets being the numbering or guessing side 102c, and the other sides or facets being fabric sides 104c, 108c, and 106c having at least one fabric material (not shown) attached onto, or be comprised of at least one fabric material (not shown). Numbering side or guessing side 102c provides an identifying presentation to the human, while the fabric sides 104c, 108c, and 106c provide sensing presentations to the human. The numbering side may also have at least one fabric material attached onto, or be comprised of at least one fabric material, and therefore function as both an identifying presentation and a sensing presentation.

In still yet another preferred embodiment, as shown in FIG. 1d, a sensor tactile kit may include a set of object(s) 100d. Object 100d may comprise one numbering or guessing surface 102d, and a fabric surface 104d that may or may not have a rigid shape. Numbering surface or guessing surface 102d provides an identifying presentation to the human, while the fabric surface 104d provides a sensing presentation to the human. Fabric surface 104d may include at least one fabric material (not shown) attached onto, or be comprised of at least one fabric material (not shown). The numbering surface may also have at least one fabric material attached onto, or be comprised of at least one fabric material, and therefore function as both an identifying presentation and a sensing presentation.

In a preferred embodiment, as shown in FIG. 2, the set of instructions of a sensor memory kit provides a method for using the sensory memory kit to improve a human's memory. Preferably, the method instructs a practitioner to administer to a human using a sensor memory kit upon a human in a session. The practitioner starts the session with a material of the kit, presenting the material to the human in step 200, and then instructing the human to sense the material in step 220. Using an olfactory kit, the material may be a scent and the human may smell the scent; with a sensor tactile kit, the material may a fabric or a combination of fabrics, the human may touch the material. In step 240 the practitioner further instructs the human to identify the material and records the identifying response regardless whether the response is right or wrong in step 260. Then in step 280 the practitioner instructs the human to close eyes and to discuss memories associated with the material the human senses in step 220. Preferably, the human may be encouraged to use imagination to encourage recall or to create a new image in addition to recalling at least a memory experienced during the life. Such memory may include, but not limited to major life events such as engagements, weddings, babies or pets. More preferably, the human may be encouraged to talk, write, or communicate to the practitioner in any manners about the memories elicited from sensing the material in step 220. In step 300, the practitioner records the memories the human relates in step 280. In step 320, when the human does not provide a right response in step 240 to identify the material sensed in step 220, the practitioner, in step 340, informs the human of the correct response that identifies the material the human senses in step 220 and then proceed to step 360. When the human does provide a right response in step 240 to identify the material sensed in step 220, the practitioner proceeds directly to step 360. In step 360, the practitioner instructs the human to sense the same material sensed in step 220, and in step 380, the practitioner instructs the human to identify the same material sensed in step 360 one more time.

During a session of the exercise, the practitioner repeats steps 200 through 380 for each material of the kit one by one. Preferably, the duration of step 280 may be at least 1 minute. When a human fails to communicate any memory, probing or cuingup to two times is recommended, and finally silence is acceptable and may be recorded accordingly in step 300. More preferably, the duration of step 280 may at most be about 10 minutes. Preferably, the duration of a session is at least a total of about 30 minutes long. More preferably, the duration of a session is at most about 60 minutes for a kit including 7 materials, and about 90 minutes for a kit including 10 materials.

Preferably, a sensor memory exercise may include at least one session and no limits as to the maximal number of sessions. More preferably, a sensor memory exercise may occur in both a consecutive or non-consecutive manner. Optimally, a sensor memory exercise may be practiced during a duration of 12 weeks.

Preferably, the method of using a sensor memory kit may record base-line information by keeping records of the response and accuracy of responses each time a material of the kit is administered. More preferably, the method may also provide information about a baseline for each individual, improvement rate, and the individual learning curve by administering each material of a kit twice to a human.

The embodiments of sensible materials or sensing mechanisms according to the present invention may further include other types of sensing mechanism such as hearing, seeing, tasting, and temperature perceiving. Furthermore, the identifying presentations may include, but not limited to, mechanisms such as letters, logos and symbols.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” Where the context permits, words in the above Detailed Description of the Preferred Embodiments using the singular or plural number may also include the plural or singular number respectively. The word “or” in reference to a list of two or more items, covers all of the following interpretations of the word: any of the items in the list, all of the items in the list, and any combination of the items in the list.

The above-detailed description of embodiments of the disclosure is not intended to be exhaustive or to limit the teachings to the precise form disclosed above. While specific embodiments of and examples for the disclosure are described above for illustrative purposes, various equivalent modifications are possible within the scope of the disclosure, as those skilled in the relevant art will recognize For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed, at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference in their entirety. Aspects of the disclosure can be modified, if necessary, to employ the systems, functions, and concepts of the various references described above to provide yet further embodiments of the disclosure.

These and other changes can be made to the disclosure in light of the above

Detailed Description of the Preferred Embodiments. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features or aspects of the disclosure with which that terminology is associated. In general, the terms used in the following claims should not be construed to limit the disclosures to the specific embodiments disclosed in the specification unless the above Detailed Description of the Preferred Embodiments section explicitly defines such terms. Accordingly, the actual scope of the disclosure encompasses not only the disclosed embodiments, but also all equivalent ways of practicing or implementing the disclosure under the claims.

Accordingly, although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention.

What is claimed is:

1. A kit for improving or stimulating a human's memory, the kit comprising:
a set of sensible materials for the human to sense and a set of instructions for using the kit, wherein the set of instructions comprises the steps of:
(a) presenting the human with a material from a set of sensible materials;
(b) instructing the human to sense the material;
(c) instructing the human to identify the material;
(d) recording the response;
(e) eliciting from the human at least a memory associated with the material;
(f) recording the memory elicited in step (e);
(g) instructing the human to sense the same material that the human is instructed to sense in the step (b); and
(h) instructing the human to identify the material the human is instructed to sense in the step (g).

2. The kit of claim 1, wherein the set of materials comprises materials for the human to sense with a same sensing mechanism.

3. The kit of claim 2, wherein the sensing mechanism is selected from the group consisting of smelling, touching, tasting, seeing, hearing, and perceiving temperature.

4. The kit of claim 2, wherein materials of the set of materials are organized in an identifiable series, the series being ordered according to levels of difficulty for the human to identify upon sensing each of the set of materials.

5. The kit of claim 4, wherein the set of materials is a set of scents, and wherein each scent is selected from a different primary scent category.

6. The kit of claim 4, wherein each material of the set of materials is a material that elicits tactile experience.

7. The kit of claim 6, wherein each material of the set of materials is selected from the group silk, corduroy, towel, flannel, plastic or vinyl, burlap, refined or coarse wool, polyester, taffeta, denim, spandex, georgette, polypropylene, satin, fiberglass, filter, carbon, vinyl, plain, blended, polytetrafluoroethylene (PTFE), crewel, stretch, linen, ramie, hemp, leather, jute, rayon, acetate, chiffon, acrylic, organza, latex, nylon, velvet, viscose, grey fabric, reflective fabric, quilted fabric, polyethylene fabric, narrow fabric, laminated fabric, flocked fabric, flame resistant fabric, and the combination thereof.

8. A method for improving or stimulating a human's memory, the method comprising the steps of:
(a) presenting the human with a material from a set of sensible materials;
(b) instructing the human to sense the material;
(c) instructing the human to identify the material;
(d) recording response;
(e) eliciting from the human at least a memory associated with the material;
(f) recording the memory elicited in step (e);
(g) instructing the human to sense the same material that the human is instructed to sense in the step (b); and
(h) instructing the human to identify the material the human is instructed to sense in the step (g).

9. The method of claim 8, wherein the step (f) further comprises, after recording the memory elicited, informing the human of a right response that identifies the material if the response provided by the human is not right.

10. The method of claim 8, wherein the steps (a) through (h) are repeated for each material of the set of sensible materials.

11. The method of claim 9, wherein the steps (a) through (h) are repeated for each material of the set of sensible materials.

12. An apparatus for a human to improve memory, the apparatus comprising a plurality of sensible materials and a plurality of mechanisms to present each of the plurality of the sensible materials to the human, wherein each of the plurality of the mechanism comprises an identifying presentation and a sensing presentation, the identifying presentation corresponding to the sensing presentation.

13. The apparatus of claim 12, wherein each of the plurality of the materials is a scent selected from a different primary scent category, the identifying presentation of each of the plurality of the mechanism is a number, letter, logo or symbol, and the sensing presentation of the each of the plurality of the mechanism comprises a scent retainer and a scent retainer enclosure, wherein the scent retainer retains the scent, the scent retainer enclosure stores the scent retainer retaining the scent in an air-tight manner, the scent retainer enclosure does not affect the quality of the scent, and neither the scent retainer nor the scent retainer enclosure interferes with the human sensing the scent.

14. The apparatus of claim 12, wherein each of the plurality of the materials is a fabric, the identifying presentation of each of the plurality of the mechanism is a number, letter, logo or symbol, and the sensing presentation of the each of the plurality of the mechanisms is an object comprising a numbering surface including the identifying presentation, and a sensing surface which is comprised of at least one fabric or has at least one fabric attached onto.

15. The apparatus of claim 14, wherein the object further comprises at least one sensing surface, the sensing surfaces being comprised of at least one fabric or having at least one fabric attached onto.

16. The apparatus of claim 14, wherein the numbering surface and the sensing surface is the same surface.

17. A kit comprising:
(a) a sheet of material; and
(b) at least two sensing mechanisms, wherein the sensing mechanism are attached to the sheet of material.

18. The kit of claim 17 wherein the sensing mechanisms are selected from the group consisting of nasal sensing mechanism, tactile sensing mechanism, tasting mechanism, seeing mechanism, hearing mechanism, balance sensing mechanism, acceleration sensing mechanism, temperature sensing mechanism and mixtures thereof.

19. The kit of claim 17 wherein the sensing mechanisms are enclosed.
